(19) United States
(12) Patent Application Publication
(10) Pub. No.: US 2025/0203222 A1
(43) Pub. Date: Jun. 19, 2025

(54) CORRECTION SYSTEM AND METHOD FOR ELIMINATING NON-UNIFORM DISTRIBUTION OF LIGHT FIELD DURING HYPERSPECTRAL IMAGE ACQUISITION

(71) Applicants: Zhejiang University, Hangzhou City (CN); Hainan Institute of Zhejiang University, Sanya City (CN)

(72) Inventors: Xiaoli LI, Hangzhou City (CN); Yong HE, Hangzhou City (CN); Yuying ZHANG, Hangzhou City (CN); Xuelun LUO, Hangzhou City (CN); Qinghai HE, Hangzhou City (CN); Xuechen ZHANG, Hangzhou City (CN); Huahao YU, Hangzhou City (CN)

(21) Appl. No.: 18/980,432

(22) Filed: Dec. 13, 2024

(30) Foreign Application Priority Data
Dec. 15, 2023 (CN) 202311723183.5

(51) Int. Cl. H04N 23/76; G01J 3/28; H04N 23/56; H04N 23/71; H04N 25/10; H04N 25/71

(52) U.S. Cl. CPC H04N 23/76; G01J 3/2823; H04N 23/71; H04N 25/10; H04N 25/71; G01J 2003/2853; H04N 23/56

(57) ABSTRACT

Disclosed are a correction system and method for eliminating non-uniform distribution of a light field during hyperspectral image acquisition, to effectively eliminate the impact of non-uniform light field distribution caused by halogen light illumination on acquisition of hyperspectral image information. The correction method includes acquiring hyperspectral images A corresponding to two standard whiteboards with different reflectance under illumination of a halogen light source. A hyperspectral image B is acquired corresponding to a tea leaf sample under illumination of the same light source. Spatial distribution characteristics of a light field are obtained based on the hyperspectral images A. Pixels in the hyperspectral images A and B are spatially matched. Light field correction is performed on a pixel of the sample in the hyperspectral image B, and reflectance correction is performed on the sample after the light field correction.

### CROSS REFERENCE TO RELATED APPLICATION

This patent application claims the benefit and priority of Chinese Patent Application No. 202311723183.5, filed with the China National Intellectual Property Administration on Dec. 15, 2023, the disclosure of which is incorporated by reference herein in its entirety as part of the present application.

### TECHNICAL FIELD

The present disclosure relates to the technical field of hyperspectral image processing, and in particular, to a correction system and method for eliminating non-uniform distribution of a light field during hyperspectral image acquisition.

### BACKGROUND

Hyperspectral images contain rich spectral and spatial information, directly reflecting the composition and structural differences of substances, and are widely used at present. Halogen lamps are inexpensive, have high output power, and good stability, but they have poor light uniformity. When halogen lamps are used as light sources to acquire hyperspectral images, the non-uniform illumination in the sample scanning area leads to the inability to reflect the spatial distribution characteristics of the sample.

### SUMMARY

An objective of the present disclosure is to provide a correction system and method for eliminating non-uniform distribution of a light field during hyperspectral image acquisition. By correcting the light field and leaf reflectance, the system effectively eliminates the impact of non-uniform light field distribution caused by halogen light illumination on hyperspectral image acquisition and can correct the reflectance of hyperspectral data.

The technical solution adopted by the present disclosure to solve the technical problem is as follows: a correction system for eliminating non-uniform distribution of a light field during hyperspectral image acquisition, including a CCD camera, an imaging spectrometer, a light source, a lens, a first standard whiteboard, a second standard whiteboard, and a darkroom. The CCD camera is located in an upper portion of the darkroom; the imaging spectrometer is located under the CCD camera with a top of the imaging spectrometer connected to the CCD camera; the lens is provided at a bottom of the imaging spectrometer; the light source is provided on left and right sides of the lens; the second standard whiteboard is disposed below the lens, and the first standard whiteboard is placed on the second standard whiteboard.

Furthermore, the first standard whiteboard has a reflectance of 20%, and the second standard whiteboard has a reflectance of 60%.

The present disclosure further provides a correction method based on the correction system for eliminating non-uniform distribution of a light field during hyperspectral image acquisition, including the following steps:
S1: acquiring hyperspectral images A corresponding to the first standard whiteboard and the second standard whiteboard under illumination of a halogen light source;
S2: acquiring a hyperspectral image B corresponding to a sample under illumination of the same light source;
S3: obtaining spatial distribution characteristics of a light field based on the hyperspectral images A;
S4: spatially matching pixels in the hyperspectral images A and the hyperspectral image B;
S5: performing light field correction on a pixel of the sample in the hyperspectral image B; and
S6: performing reflectance correction on the sample after the light field correction.

Further, S3 specifically includes:
S3.1: marking a center of the first standard whiteboard in the hyperspectral images A as (x₁, y₁);
S3.2: quantitatively analyzing light field distribution of a pixel (i, j) in the hyperspectral images A using the following formula: C_{(i,j)}=R_{(i,j)}/Ave, to obtain the spatial distribution characteristics of the light field;
where Ave=Σ_{iϵ(0,g],jϵ(0,k],i,jϵN}R_{(i,j)}/(g×k), R_{(i,j)} represents a spectrum of the pixel (i, j), and g, k represents a size of a sample detection area; and
S3.3: recording a relative position S_{(i,j)}=(aᵢ−x₁, bⱼ−y₁) of the pixel (i, j) to the center of the first standard whiteboard, where (aᵢ, bⱼ) denotes a position of the pixel (i, j).

Further, S4 specifically includes:
S4.1: marking a center of the first standard whiteboard in the hyperspectral image B as (x₂, y₂);
S4.2: recording a relative position S_{(m,n)}=(cₘ−x₂, dₙ−y₂) of a pixel (m, n) of the sample in the hyperspectral image B to the center of the first standard whiteboard, where (cₘ, dₙ) represents a position of the pixel (m, n), mϵ(0, g], nϵ(0, k], m, nϵN, and g, k represents the size of the sample detection area; when |(aᵢ−x₁)−(cₘ−x₂)|Λ|(bⱼ−y₁)−(dₙ−y₂)|≤; 2, the pixel (i, j) and the pixel (m, n) are considered to be at the same position.

Further, S5 specifically includes:

S5.1: when the pixel (i, j) and the pixel (m, n) are considered to be at the same position, performing light field correction on the pixel (m, n) of the sample in the hyperspectral image B using the following formula:

$${C}_{( m , n )} = \frac{{R}_{( m , n )}}{{C}_{( i , j )}} ;$$

where R_{(m,n)} represents a spectrum of the pixel (m, n).

Further, S6 specifically includes:
S6.1: taking an average spectrum R_{B}_{₂} of the first standard whiteboard in the hyperspectral image B, and taking an average spectrum R_{B}_{₁} of the second standard whiteboard around the first standard whiteboard;
S6.2: performing fitting using points [R_{B}_{₁}(s), 60] and [R_{B}_{₂}(s), 20] to obtain a linear fitting formula: y=eₛx+fₛ, where sϵ(0, t], tϵN, t represents the number of bands; R_{B}_{₁} (s) represents a digital number (DN) value of R_{B}_{₁} when the band is s, eₛ and fₛ are coefficients, and X represents reflectance; and
S6.3: substituting a light field correction result C_{(m,n)}(s) of the pixel (m, n) into the formula y=eₛx+fₛ to obtain a reflectance correction result of the pixel (m, n), where C_{(m,n)}(s) represents the light field correction result of the pixel (m, n) when the band is s.

The present disclosure has the following beneficial effects: By acquiring a hyperspectral image corresponding to standard whiteboards with reflectance of 20% and 60% as well as a hyperspectral image corresponding to a sample under halogen light illumination, light field correction is performed on pixels of the sample based on the spatial distribution characteristics of the light field, and average spectra of the two standard whiteboards are fitted, to the reflectance of the sample after light field correction, thereby effectively eliminating the impact of non-uniform light field distribution under halogen light illumination on hyperspectral image acquisition, and enabling reflectance correction for hyperspectral data.

### BRIEF DESCRIPTION OF THE DRAWINGS

FIG. 1 is a structural diagram of a correction system according to the present disclosure;

FIG. 2 is a flowchart of a correction method according to the present disclosure;

FIG. 3 is an image of a sample detection area in hyperspectral images A according to the present disclosure;

FIG. 4 is an image of a sample detection area in a hyperspectral image B according to the present disclosure;

FIG. 5 is an image of a sample after light field correction according to the present disclosure;

FIG. 6A is a schematic diagram of comparison between an original spectrum DN value and a DN value after light field correction at 550 nm for the sample;

FIG. 6B is a schematic diagram of comparison between an original spectrum DN value and a DN value after light field correction at 680 nm for the sample;

FIG. 6C is a schematic diagram of comparison between an original spectrum DN value and a DN value after light field correction at 750 nm for the sample;

FIG. 7A is a schematic diagram of fitting at 550 nm;

FIG. 7B is a schematic diagram of fitting at 680 nm;

FIG. 7C is a schematic diagram of fitting at 750 nm;

FIG. 8A is a schematic diagram of comparison between reflectance after single correction and reflectance after fitting correction at 550 nm;

FIG. 8B is a schematic diagram of comparison between reflectance after single correction and reflectance after fitting correction at 680 nm;

FIG. 8C is a schematic diagram of comparison between reflectance after single correction and reflectance after fitting correction at 750 nm;

FIG. 9 illustrates a statistical analysis of an original spectral line DN value and a DN value after light field correction at 550 nm for the sample;

FIG. 10 illustrates a statistical analysis of an original spectral line DN value and a DN value after light field correction at 680 nm for the sample;

FIG. 11 illustrates a statistical analysis of an original spectral line DN value and a DN value after light field correction at 750 nm for the sample;

FIG. 12 illustrates a statistical analysis of reflectance after single correction and reflectance after fitting correction at 550 nm for the sample;

FIG. 13 illustrates a statistical analysis of reflectance after single correction and reflectance after fitting correction at 680 nm for the sample; and

FIG. 14 illustrates a statistical analysis of reflectance after single correction and reflectance after fitting correction at 750 nm for the sample.

Meanings of reference numerals in the figures: 1: darkroom; 2: first standard whiteboard; 3: sample detection area; 4: second standard whiteboard; 5: lens; 6: light source; 7: imaging spectrometer; 8: CCD camera.

### DETAILED DESCRIPTION OF THE EMBODIMENTS

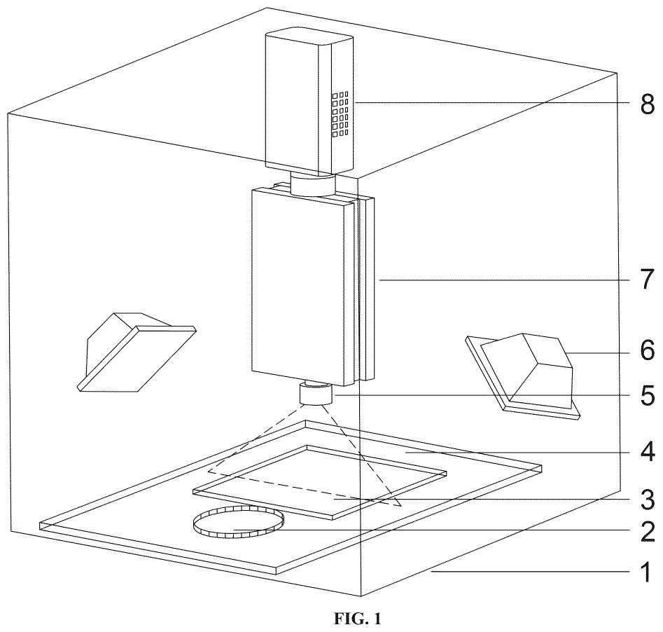

As shown in FIG. 1, a correction system for eliminating non-uniform distribution of a light field during hyperspectral image acquisition of the present disclosure includes a CCD camera 8, an imaging spectrometer 7, a light source 6, a lens 5, a first standard whiteboard 2, a second standard whiteboard 4, and a darkroom 1. The CCD camera 8 is disposed in an upper portion of the darkroom 1. The imaging spectrometer 7 is located under the CCD camera 8 with a top of the imaging spectrometer 7 connected to the CCD camera 8. The lens 5 is provided at a bottom of the imaging spectrometer 7. The lens 5 is a hyperspectral lens. The light source 6 is provided on left and right sides of the lens 5. The light source 6 is a halogen lamp light source. The second standard whiteboard 4 is disposed below the lens 5, and the first standard whiteboard 2 is placed on the second standard whiteboard 4. The first standard whiteboard 2 has a reflectance of 20%, and the second standard whiteboard 4 has a reflectance of 60%. A sample detection area 3 is marked at the center of the second standard whiteboard 4, and the sample is placed in the sample detection area 3 during use.

The objective of the present disclosure is to effectively eliminate the impact of non-uniform light field distribution under halogen light illumination on hyperspectral image acquisition by correcting the light field and leaf reflectance, and to achieve reflectance correction for hyperspectral data. To achieve the foregoing objective, the correction method of the present disclosure is described in detail below in conjunction with the accompanying drawings.

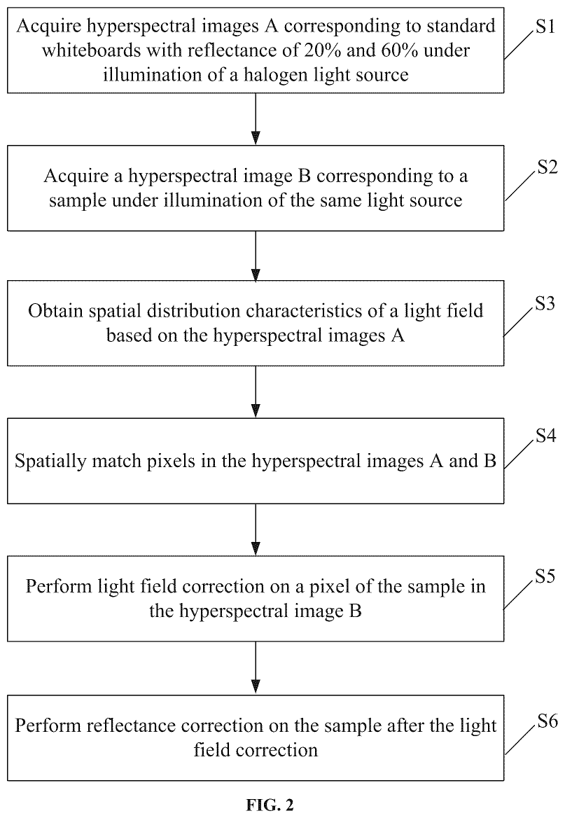

As shown in FIG. 2, a correction method for eliminating non-uniform distribution of a light field during hyperspectral image acquisition includes the following steps:

Step S1: Acquire hyperspectral images A corresponding to a first standard whiteboard 2 and a second standard whiteboard 4 under illumination of a halogen light source 6, and define a sample detection area 3.

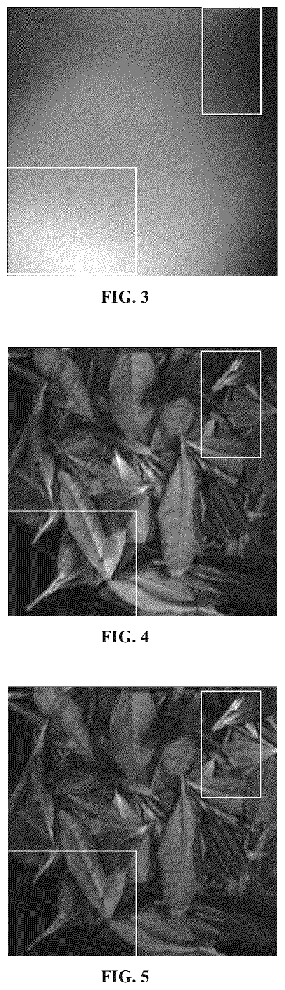

Before hyperspectral image acquisition, the second standard whiteboard 4 is placed 60 cm below the lens 5, and the first standard whiteboard 2 is secured on the second standard whiteboard 4. The sample detection area 3 is defined at the center of the second standard whiteboard 4. To obtain clear and undistorted images, an imaging spectrometer 7 is adjusted to have a moving speed of 26 mm/s and an exposure time of 40 ms. The hyperspectral images A obtained under the illumination of the halogen light source are shown in FIG. 3. Due to the poor light uniformity of the halogen light source, the illumination distribution in the sample detection area in the hyperspectral images A is uneven, with parts highlighted in the image showing overexposure or underexposure.

Step S2: Acquire a hyperspectral image B corresponding to a tea leaf sample under illumination of the same light source, as shown in FIG. 4.

Step S3: Obtain spatial distribution characteristics of a light field based on the hyperspectral images A.

Specifically,

S3.1: Select a hyperspectral image corresponding to 633 nm in the hyperspectral images A (at the band of 633 nm, there is a clear distinction between the first standard whiteboard 2 and the second standard whiteboard 4, allowing effective masking for the first standard whiteboard 2), appropriately crop the image, find a position corresponding to the first standard whiteboard 2, and create a mask image corresponding to the first standard whiteboard 2. Binary image segmentation is performed on the hyperspectral image corresponding to 633 nm in the hyperspectral images A by using the mask image, to obtain a segmented area corresponding to the first standard whiteboard 2.

S3.2: Perform dilation and erosion processing on the segmented area corresponding to the first standard whiteboard 2 by applying dilation and erosion operations in digital morphology, to obtaining an area corresponding to the first standard whiteboard 2.

S3.3: Extract connected regions from the image after dilation and erosion by using a connected-component labeling method in binary image analysis, with a length and a width of the connected region containing the first standard whiteboard 2 ranging from 100 to 300; and through selection, obtain a center (x₁, y₁) of the first standard whiteboard 2 in the hyperspectral images A.

S3.4: Extract a spectrum R_{(i,j)} of a pixel (i, j) in the corresponding sample detection area 3 of the hyperspectral images A, and quantitatively analyze light field distribution of the pixel (i, j) in the hyperspectral images A using the following formula:

$${C}_{( i , j )} = \frac{{R}_{( i , j )}}{A v e} ,$$

to obtain the spatial distribution characteristics of the light field.

$$Ave = \frac{{\sum }_{i ϵ ( 0 , g ] , j ϵ ( 0 , k ] , i , j ϵ {N}^{R} ( i , j )}}{( g \times k )} ;$$

g, k represents a size of the sample detection area 3.

S3.5: Record a relative position S_{(i,j)}=(aᵢ−x₁, bⱼ−y₁) of the pixel (i, j) to the center of the first standard whiteboard 2, where (aᵢ, bⱼ) represents a position of the pixel (i, j).

Step S4: Spatially match pixels in the hyperspectral images A and the hyperspectral image B.

S4.1: Obtain a center (x₂, y₂) of the first standard whiteboard 2 in the hyperspectral image B by using the same method as in step S3. A hyperspectral image corresponding to 733 nm in the hyperspectral image B is selected (at the band of 733 nm, there is a clear distinction between the sample and the second standard whiteboard 4, allowing effective masking for the sample), and a mask image corresponding to the sample in the sample detection area 3 is created; binary image segmentation is performed on the hyperspectral image corresponding to 733 nm in the hyperspectral image B by using the mask image, to obtain a segmented area corresponding to the sample.

S4.2: Extract a spectrum R_{(m,n)} of a pixel (m, n) of the sample in the sample detection area 3 corresponding to the hyperspectral image B; record a relative position S_{(m,n)}=(cₘ−x₂, dₙ−y₂) of the pixel (m, n) of the sample to the center of the first standard whiteboard 2 in the hyperspectral image B, where (cₘ, dₙ) represents a position of the pixel (m, n), and mϵ(0, g], nϵ(0, k], m, nϵN; g, k represents the size of the sample detection area 3; when |(aᵢ−x₁)−(cₘ−x₂)|Λ|(bⱼ−y₁)−(dₙ−y₂)|≤2, the pixel (i, j) in the hyperspectral images A and the pixel (m, n) in the hyperspectral image B are considered to be at the same position.

Step S5: Perform light field correction on a pixel of the sample in the hyperspectral image B.

When the pixel (i, j) and the pixel (m, n) are considered to be at the same position, light field correction is performed on the pixel (m, n) of the sample in the hyperspectral image B by using the following formula:

$${C}_{( m , n )} = \frac{{R}_{( m , n )}}{{C}_{( i , j )}} ,$$

to obtain a light field correction result for the sample, as shown in FIG. 5. It can be seen from the figure that the overly bright and dark parts in the sample detection area 3 are corrected.

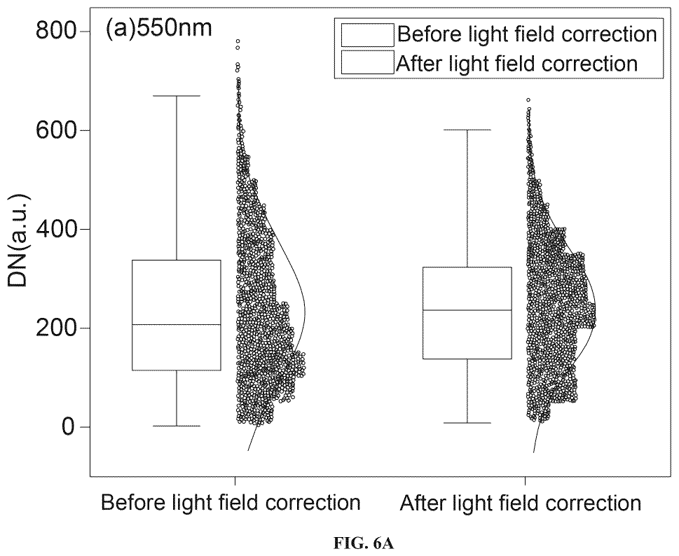

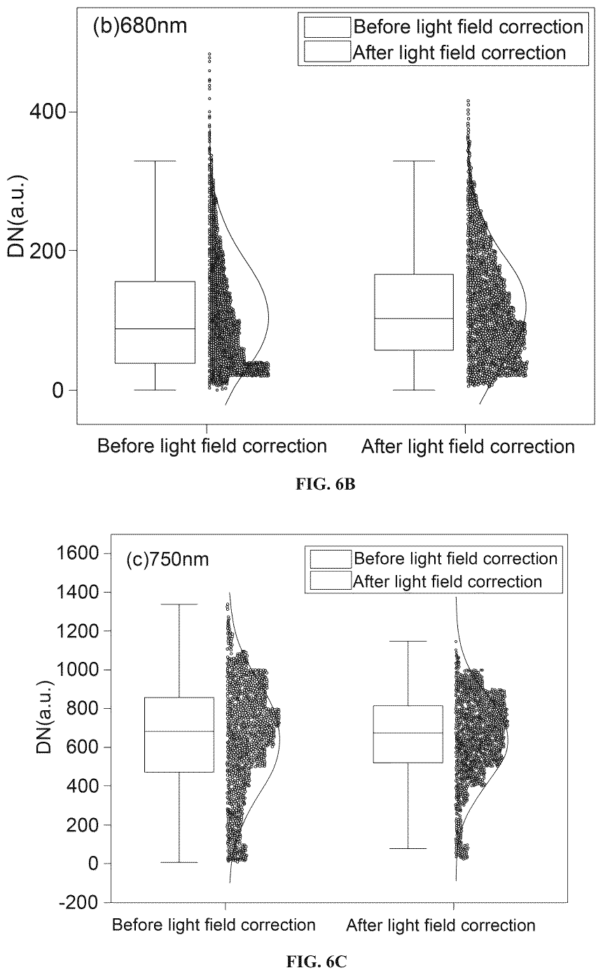

By observing the original spectral image of the tea sample and the spectral image of the sample after light field correction, three bands are selected, which are 550 nm (peak), 680 nm (valley), and 750 nm (peak). The original spectral DN values of the sample in the three bands are compared with the DN values after light field correction, as shown in FIG. 6A, FIG. 6B, and FIG. 6C.

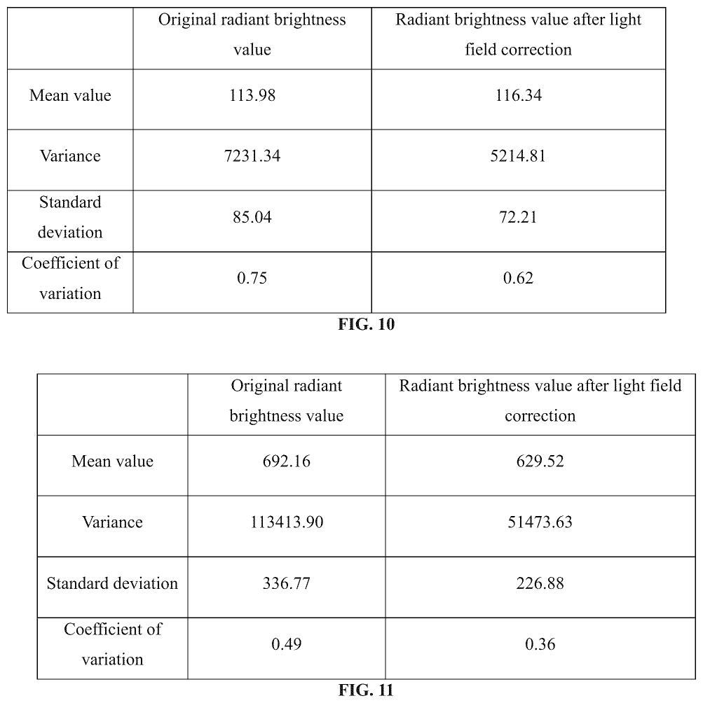

The statistical analysis for the original spectral line DN values of the sample in the three bands and the DN values after light field correction is shown in FIG. 9, FIG. 10, and FIG. 11. By comparing the results before and after light field correction, it is evident that the data distribution before correction is skewed, while after correction, the data distribution becomes normal, and the coefficient of variation decreases, indicating that the light field correction method provided by the present disclosure can effectively eliminate the impact of non-uniform light field distribution caused by halogen light illumination on the acquisition of hyperspectral image information.

Step S6: Perform reflectance correction on the sample after the light field correction.

S6.1: Take an average spectrum R_{B}_{₂} of the first standard whiteboard 2 in the hyperspectral image B, and take an average spectrum R_{B}_{₁} of the second standard whiteboard 4 around the first standard whiteboard 2, where R_{B}_{₂} corresponds to a reflectance of 20%, and R_{B}_{₁} corresponds to a reflectance of 60%.

S6.2: Perform fitting using points [R_{B}_{₁}(s), 60] and [R_{B}_{₂}(s), 20], to obtain a linear fitting formula: Re(s)=eₛx+fₛ.
where sϵ(0, t], tϵN, and t is the number of bands; R_{B}_{₁}(s) is a DN value of R_{B}_{₁} when the band is s; R_{B}_{₂}(s) is a DN value of R_{B}_{₂} when the band is s, x represents reflectance, and eₛ and fₛ are coefficients.

S6.3: Substitute a light field correction result C_{(m,n)} (s) of the pixel (m, n) into the formula Re(s)=eₛx+fₛ to obtain a reflectance fitting correction result Re(s) of the pixel (m, n), where C_{(m,n)}(s) represents the light field correction result of the pixel (m, n) when the band is s.

S6.4: When the pixel (I, j) in the hyperspectral images A and the pixel (m, n) in the hyperspectral image B are considered to be at the same position, perform reflectance correction on the pixel (m, n) of the sample in the hyperspectral image B by using the following formula:

$$R e = \frac{{R}_{( m , n )}}{{R}_{( i , j ) / 0.6}} ,$$

to obtain a single reflectance correction result for the sample. R_{(m, n)} is the spectrum of the pixel (m, n) of the sample in the hyperspectral image B, and R_{(i,j)} is the spectrum of the pixel (i, j) in the corresponding sample detection area 3 of the hyperspectral images A. Since no sample is placed in the corresponding sample detection area 3 in the hyperspectral images A, the second standard whiteboard 4 is scanned in the sample detection area 3, where the second standard whiteboard 4 has a reflectance of 60%. Therefore, to obtain the sample reflectance correction result, the following formula needs to be used:

$$\frac{{R}_{( m , n )}}{{R}_{( i , j ) / 0.6}} ,$$

which is a general formula for hyperspectral reflectance correction. Typically, a standard whiteboard with 100% reflectance is used for hyperspectral scanning, but a whiteboard with 60% reflectance is adopted herein. Therefore, the formula needs to be divided by 0.6.

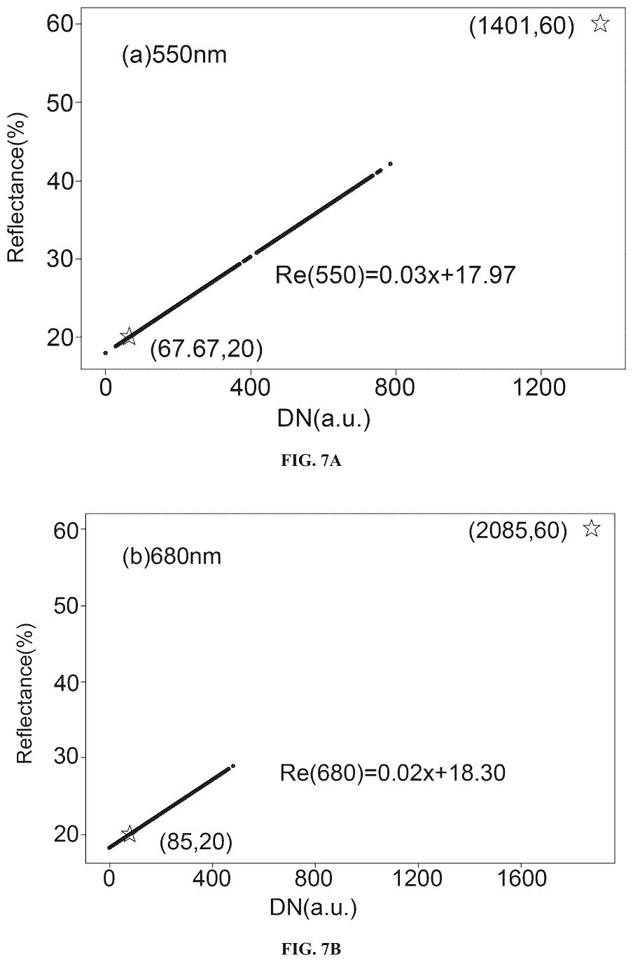

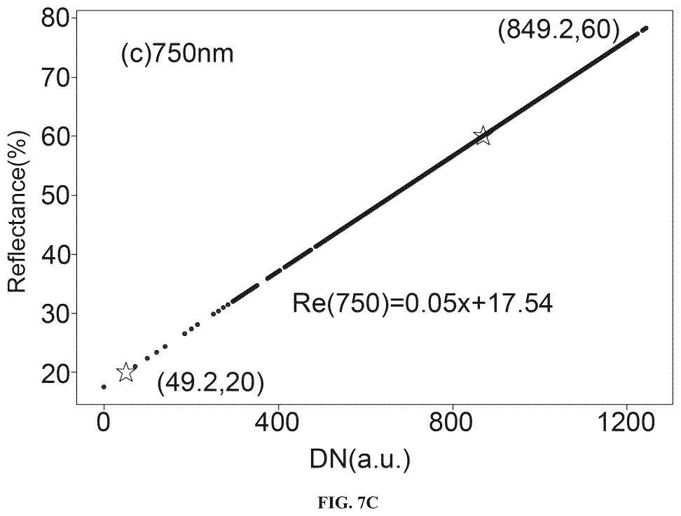

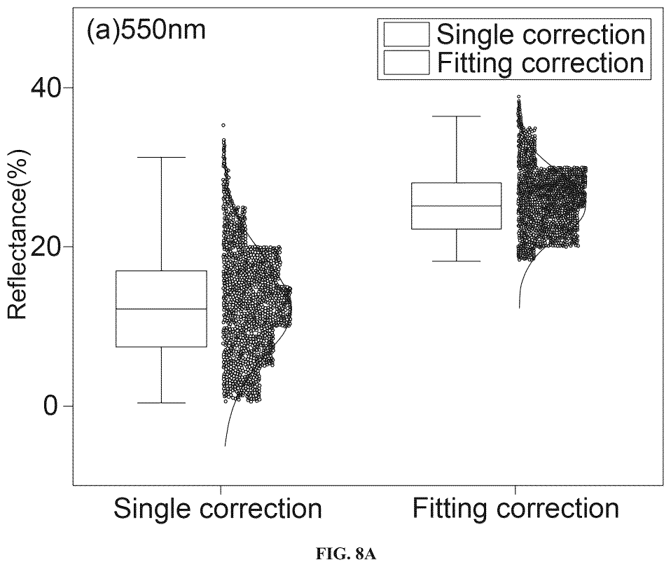

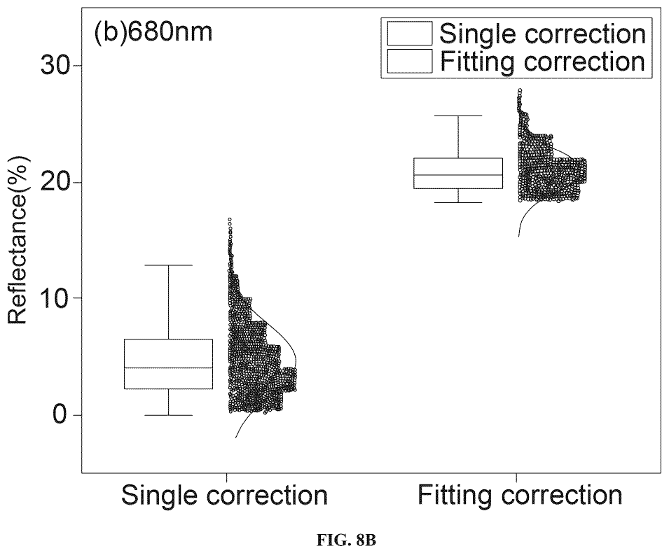

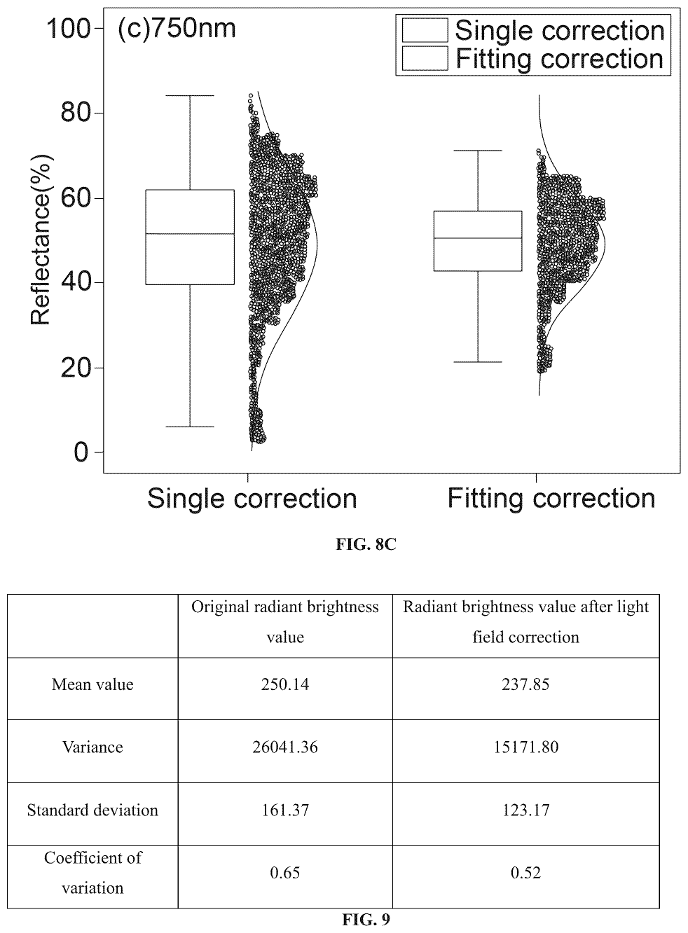

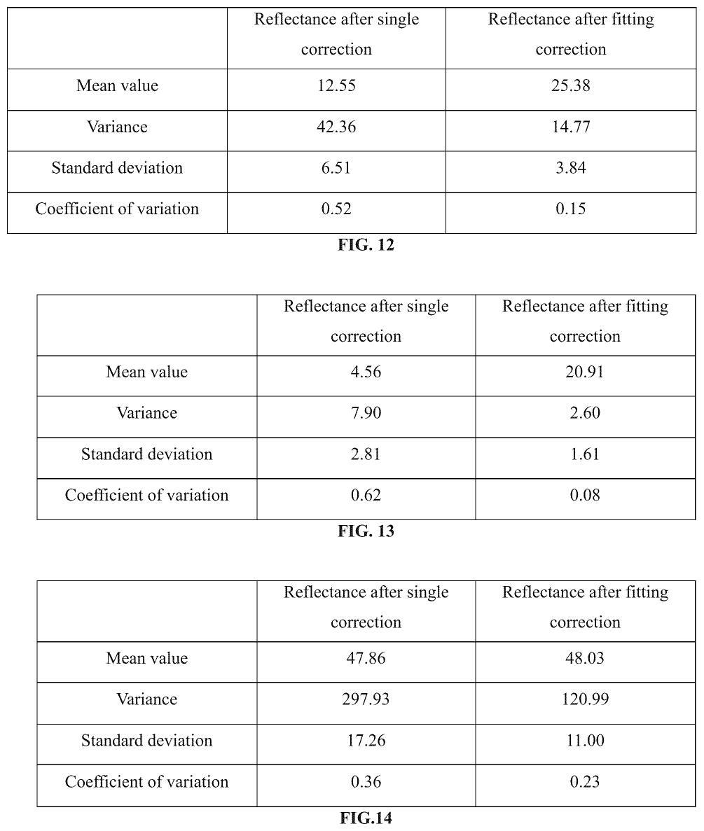

Three bands are selected, which are 550 nm (peak), 680 nm (valley), and 750 nm (peak). The reflectance after single correction and the reflectance after fitting correction are compared for the sample in the three bands. The comparison results are shown in FIG. 6A, FIG. 6B, FIG. 6C, FIG. 7A, FIG. 7B, FIG. 7C, FIG. 8A, FIG. 8B, and FIG. 8C. The statistical analysis for the reflectance after single correction and the reflectance after fitting correction of the sample in the three bands is shown in FIG. 12, FIG. 13, and FIG. 14.

From the results of the two different reflectance correction methods (single correction and fitting correction), it is observed that the results after correction using the second standard whiteboard 4 with a single reflectance of 60% are skewed, while the results after fitting using the first standard whiteboard 2 with a reflectance of 20% and the second standard whiteboard 4 with a reflectance of 60% are normally distributed, and the coefficient of variation decreases. This indicates that the reflectance correction method provided by the present disclosure can better correct reflectance in the case of non-uniform light field distribution.

Through the embodiments, it is demonstrated that the light field and reflectance correction method proposed by the present disclosure can effectively eliminate the impact of non-uniform light field distribution caused by halogen light illumination on the acquisition of hyperspectral image information and can achieve the purpose of reflectance correction for hyperspectral data.

What is claimed is:

1. A correction system for eliminating non-uniform distribution of a light field during hyperspectral image acquisition, comprising:
a charge-coupled device (CCD) camera,
an imaging spectrometer positioned under the CCD camera with a top of the imaging spectrometer being connected to the CCD camera,
a light source,
a lens provided at a bottom of the imaging spectrometer and having the light source positioned on left and right sides of the lens,
a first standard whiteboard,
a second standard whiteboard disposed below the lens, the first standard whiteboard being placed on the second standard whiteboard, and
a darkroom, the CCD camera being positioned in an upper portion of the darkroom connected to the CCD camera;

2. The correction system for eliminating non-uniform distribution of a light field during hyperspectral image acquisition according to claim 1, wherein the first standard whiteboard has a reflectance of 20%, and the second standard whiteboard has a reflectance of 60%.

3. A correction method based on the correction system for eliminating non-uniform distribution of a light field during hyperspectral image acquisition according to claim 1, comprising:
S1: acquiring hyperspectral images A corresponding to the first standard whiteboard and the second standard whiteboard under illumination of a halogen light source;
S2: acquiring a hyperspectral image B corresponding to a sample under illumination of the same light source;
S3: obtaining spatial distribution characteristics of a light field based on the hyperspectral images A;
S4: spatially matching pixels in the hyperspectral images A and the hyperspectral image B;
S5: performing light field correction on a pixel of the sample in the hyperspectral image B; and
S6: performing reflectance correction on the sample after the light field correction.

4. The correction method for eliminating non-uniform distribution of a light field during hyperspectral image acquisition according to claim 3, wherein S3 comprises:
S3.1: marking a center of the first standard whiteboard in the hyperspectral images A as (x₁, y₁);
S3.2: quantitatively analyzing light field distribution of a pixel (i, j) in the hyperspectral images A using the following formula:
$${C}_{( i , j )} = \frac{{R}_{( i , j )}}{A v e} ,$$
to obtain the spatial distribution characteristics of the light field;
wherein
$$Ave = \frac{{\sum }_{i ϵ ( 0 , g ] , j ϵ ( 0 , k ] , i , j ϵ {N}^{R} ( i , j )}}{( g \times k )} ,$$
R_{(i,j)} represents a spectrum of the pixel (i, j), and g, k represents a size of a sample detection area; and
S3.3: recording a relative position S_{(i,j)}=(aᵢ−x₁, bⱼ−y₁) of the pixel (i, j) to the center of the first standard whiteboard, wherein (aᵢ, bⱼ) denotes a position of the pixel (i, j).

5. The correction method for eliminating non-uniform distribution of a light field during hyperspectral image acquisition according to claim 4, wherein S4 comprises:
S4.1: marking a center of the first standard whiteboard in the hyperspectral image B as (x₂, y₂);
S4.2: recording a relative position S_{(m,n)}=(cₘ−x₂, dₙ−y₂) of a pixel (m, n) of the sample in the hyperspectral image B to the center of relative first standard whiteboard, wherein (cₘ, dₙ) represents a position of the pixel (m, n), mϵ(0, g], nϵ(0, k], m, nϵN, and g, k represents the size of the sample detection area; when |(aᵢ−x₁)−(cₘ−x₂)|Λ|(bⱼ−y₁)−(dₙ−y₂)|≤2, the pixel (i, j) and the pixel (m, n) are considered to be at the same position.

6. The correction method for eliminating non-uniform distribution of a light field during hyperspectral image acquisition according to claim 5, wherein S5 comprises:
when the pixel (i, j) and the pixel (m, n) are considered to be at the same position, performing light field correction on the pixel (m, n) of the sample in the hyperspectral image B using the following formula:
$${C}_{( m , n )} = \frac{{R}_{( m , n )}}{{C}_{( i , j )}} ;$$
wherein R_{(m,n)} represents a spectrum of the pixel (m, n) of the sample.

7. The correction method for eliminating non-uniform distribution of a light field during hyperspectral image acquisition according to claim 6, wherein S6 comprises:
S6.1: taking an average spectrum R_{B}_{₂} of the first standard whiteboard in the hyperspectral image B, and taking an average spectrum R_{B}_{₁} of the second standard whiteboard around the first standard whiteboard;
S6.2: performing fitting using points [R_{B}_{₁}(s), 60] and [R_{B}_{₂}(s), 20] to obtain a linear fitting formula: y=eₛx+fₛ, wherein sϵ(0, t], tϵN, t represents the number of bands; R_{B}_{₁} (s) represents a digital number (DN) value of R_{B}_{₁} when the band is s, X represents reflectance, eₛ and fₛ are coefficients; and
S6.3: substituting a light field correction result C_{(m,n)}(s) of the pixel (m, n) into formula y=eₛx+fₛ to obtain a reflectance correction result of the pixel (m, n), wherein C_{(m,n)}(s) represents the light field correction result of the pixel (m, n) when the band is s.

8. The correction method for eliminating non-uniform distribution of a light field during hyperspectral image acquisition according to claim 3, wherein the first standard whiteboard has a reflectance of 20%, and the second standard whiteboard has a reflectance of 60%.

9. The correction method for eliminating non-uniform distribution of a light field during hyperspectral image acquisition according to claim 8, wherein S3 comprises:
S3.1: marking a center of the first standard whiteboard in the hyperspectral images A as (x₁, y₁);
S3.2: quantitatively analyzing light field distribution of a pixel (i, j) in the hyperspectral images A using the following formula:
$${C}_{( i , j )} = \frac{{R}_{( i , j )}}{A v e} ,$$
to obtain the spatial distribution characteristics of the light field;
wherein
$$Ave = \frac{{\sum }_{i ϵ ( 0 , g ] , j ϵ ( 0 , k ] , i , j ϵ {N}^{R} ( i , j )}}{( g \times k )} ,$$
R_{(i,j)} represents a spectrum of the pixel (i, j), and g, k represents a size of a sample detection area; and
S3.3: recording a relative position S_{(i,j)} (aᵢ−x₁, bⱼ−y₁) of the pixel (i, j) to the center of the first standard whiteboard, wherein (aᵢ, bⱼ) denotes a position of the pixel (i, j).

10. The correction method for eliminating non-uniform distribution of a light field during hyperspectral image acquisition according to claim 9, wherein S4 comprises:
S4.1: marking a center of the first standard whiteboard in the hyperspectral image B as (x₂, y₂);
S4.2: recording a relative position S_{(m,n)}=(cₘ−x₂, dₙ−y₂) of a pixel (m, n) of the sample in the hyperspectral image B to the center of relative first standard whiteboard, wherein (cₘ, dₙ) represents a position of the pixel (m, n), mϵ(0, g], nϵ(0, k], m, nϵN, and g, k represents the size of the sample detection area; when |(aᵢ−x₁)−(cₘ−x₂)|Λ|(bⱼ−y₁)−(dₙ−y₂)|≤2, the pixel (i, j) and the pixel (m, n) are considered to be at the same position.

11. The correction method for eliminating non-uniform distribution of a light field during hyperspectral image acquisition according to claim 10, wherein S5 comprises:
when the pixel (i, j) and the pixel (m, n) are considered to be at the same position, performing light field correction on the pixel (m, n) of the sample in the hyperspectral image B using the following formula:
$${C}_{( m , n )} = \frac{{R}_{( m , n )}}{{C}_{( i , j )}} ;$$
wherein R_{(m,n)} represents a spectrum of the pixel (m, n) of the sample.

12. The correction method for eliminating non-uniform distribution of a light field during hyperspectral image acquisition according to claim 11, wherein S6 comprises:
S6.1: taking an average spectrum R_{B}_{₂} of the first standard whiteboard in the hyperspectral image B, and taking an average spectrum R_{B}_{₁} of the second standard whiteboard around the first standard whiteboard;
S6.2: performing fitting using points [R_{B}_{₁}(s), 60] and [R_{B}_{₂}(s), 20] to obtain a linear fitting formula: y=eₛx+fₛ, wherein sϵ(0, t], tϵN, t represents the number of bands; R_{B}_{₁}(s) represents a digital number (DN) value of R_{B}_{₁} when the band is s, X represents reflectance, eₛ and fₛ are coefficients; and
S6.3: substituting a light field correction result C_{(m,n)}(s) of the pixel (m, n) into formula y=eₛx+fₛ to obtain a reflectance correction result of the pixel (m, n), wherein C_{(m,n)}(s) represents the light field correction result of the pixel (m, n) when the band is s.
